(19) United States
(12) Patent Application Publication
(10) Pub. No.: US 2007/0142533 A1
(43) Pub. Date: Jun. 21, 2007

(54) Nano-silver infused polymeric composition and methods of manufacturing the same

(76) Inventors: Gil Sun Ok, Kyonggi-Do (KR); Youn Jae Lee, Kyonggi-Do (KR)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/305,866

(22) Filed: Dec. 15, 2005

(51) Int. Cl. C08K 3/08; C08L 39/04; C08L 69/00

(52) U.S. Cl. 524/440; 524/516; 524/537

(57) ABSTRACT

Methods of manufacturing a nano-silver infused polymeric compound are presented including: combining a colloidal nano-silver solution with a polymeric compound to form a pre-mix; concentrating the pre-mix to a desired concentration; discharging the pre-mix through a die such that a raw material is formed; drying the raw material at a first temperature; and combining the raw material with another polymeric compound to form the nano-silver infused polymeric compound to a desired concentration, the nano-silver infused polymeric compound suitably disposed for a molding process. In some embodiments, methods further include: after the concentrating the pre-mix, storing the pre-mix; and after the discharging the pre-mix, reducing the raw material to a desired size. In some embodiments, the colloidal nano-silver solution includes: a colloidal concentration of at least 10,000 ppm of nano-silver particles, the nano-silver particles having a diameter of less than 10 nm; and a colloidal solvent.

### CROSS REFERENCE TO RELATED APPLICATIONS

The present invention is related to the following applications, all of which are incorporated herein by reference:

Commonly assigned application entitled “NANO-SILVER INFUSED CONTAINER ARRANGEMENTS,” filed on even date herewith by the same inventors herein (Attorney Docket Number ZNUS-P007).

### BACKGROUND

Plastic containers, capable of containing and preserving perishable substances, are manufactured using injection molding techniques generally well-known in the art. Typically, a polymeric compound such as polypropylene may be molded without utilizing any specialized treatment processes. Polymeric compounds, like polypropylene, have many beneficial characteristics including high ductility and good tensile strength. These characteristics enable those skilled in the art to create a myriad of containers in any number of form factors to meet manufacturing and consumer needs.

However, containers formed from polymeric compounds using conventional techniques may suffer from undue porosity. That is, plastic containers may not be altogether air tight thus allowing oxygen or other gases contaminate contained substances. One reason for this porosity is that fine pores are formed in some polymer-polymer complexes when using typical molding techniques. In order to meet this problem, organic and inorganic antibacterial agents have been introduced to polymeric compounds during manufacturing. Unfortunately, many of these agents are in the form of a powder having a particle size on the order of several micrometers, which may, in some examples, be too large to adequately fill fine pores. Furthermore, particle size may, in some instances, be non-uniform, which may result in uneven coverage and distribution throughout a polymeric composition.

Another solution utilized to ameliorate polymeric porosity is the use of coatings. In some techniques, a polymer may be coated with an antibacterial substance. One example of an antibacterial coating used in manufacturing is Biogreen as disclosed by Korean Patent Number 10-301722. While some coatings may be theoretically effective, they may, in some examples suffer from undesirable agglomeration, which may result in uneven coverage and distribution. Furthermore, some coatings require stringent manufacturing conditions such as maintaining a non-oxygenated environment and a narrow temperature range during application. These requirements may contribute to rising manufacturing costs, which in some examples, may be undesirable.

Therefore, cost effective manufacturing techniques for alleviating porosity issues in polymeric compounds suitable for injection molding are needed. Therefore, a nano-silver infused polymeric composition and methods of manufacturing the same are presented herein.

### SUMMARY

Manufacturing techniques for providing compounds having antimicrobial properties are provided herein. Thus, methods of manufacturing a nano-silver infused polymeric compound are presented including: combining a colloidal nano-silver solution with a polymeric compound to form a pre-mix; concentrating the pre-mix to a desired concentration; discharging the pre-mix through a die such that a raw material is formed; drying the raw material at a first temperature; and combining the raw material with another polymeric compound to form the nano-silver infused polymeric compound to a desired concentration, the nano-silver infused polymeric compound suitably disposed for a molding process. In some embodiments, methods further include: after the concentrating the pre-mix, storing the pre-mix; and after the discharging the pre-mix, reducing the raw material to a desired size. In some embodiments, the colloidal nano-silver solution includes: a colloidal concentration of at least 10,000 ppm of nano-silver particles, the nano-silver particles having a diameter of less than 10 nm; and a colloidal solvent. In some embodiments the colloidal solvent includes distilled water, pure water, ethanol, and ethylene glycol. In some embodiments, the polymeric compound includes: polyvinyl-pyrrolidone, polypropylene, and polycarbonate.

In other embodiments, nano-silver infused polymeric compositions are presented including: a colloidal nano-silver solution; a polymeric compound combined with the colloidal nano-silver solution to form a pre-mix compound at a desired concentration; and a second polymeric compound combined with the pre-mix compound at another desired concentration. In some embodiments, the colloidal nano-silver solution includes: a colloidal concentration of at least 10,000 ppm of nano-silver particles, the nano-silver particles having a diameter of less than 10 nm; and a colloidal solvent. In some embodiments, the colloidal solvent includes: distilled water, pure water, ethanol, and ethylene glycol. In some embodiments, the polymeric compound includes: polyvinyl-pyrrolidone, polypropylene, and polycarbonate.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative flowchart of methods for manufacturing embodiments of the present invention;

TABLE 1 is a tabulated summary of experimental results incorporating embodiments of the present invention;

TABLE 2 is a tabulated summary of experimental results incorporating embodiments of the present invention;

TABLE 3 is a tabulated summary of experimental results incorporating embodiments of the present invention;

TABLE 4 is a tabulated summary of experimental results incorporating embodiments of the present invention;

TABLE 5 is a tabulated summary of experimental results incorporating embodiments of the present invention;

TABLE 6 is a tabulated summary of experimental results incorporating embodiments of the present invention;

TABLE 7 is a tabulated summary of experimental results incorporating embodiments of the present invention;

TABLE 8 is a tabulated summary of experimental results incorporating embodiments of the present invention; and

TABLE 9 is a tabulated summary of strains used to test embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

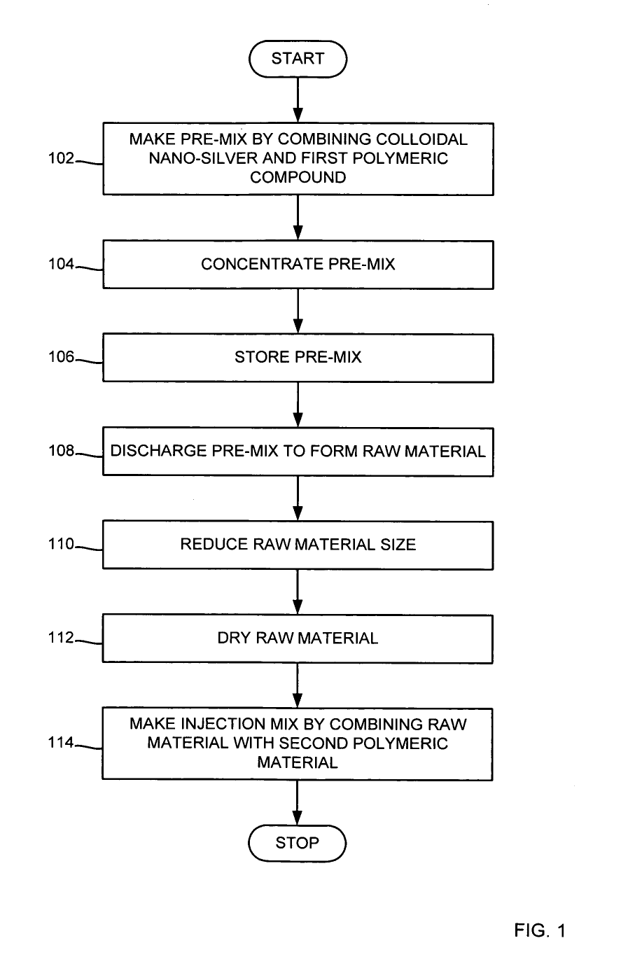

FIG. 1 is an illustrative flowchart of methods of manufacture for embodiments of the present invention. At a first step 102, a pre-mix is made by combining colloidal nano-silver and a first polymeric compound. Nano-silver consists of metallic silver particles having a size of approximately 20 nm or less. Because of the fineness of nano-silver, its use in manufacturing in powder form may have negative health effects. Some of these effects include bronchial contamination. In order to reduce negative health effects, nano-silver is used in a colloidal suspension. A colloidal nano-silver suspension includes nano-silver and a colloidal solvent such as distilled water, pure water, ethanol, and ethylene glycol. In one embodiment, a colloidal concentration of at least 10,000 ppm of nano-silver particles, the nano-silver particles having a diameter of less than 10 nm is utilized. In another embodiment, a colloidal concentration of at least 10,000 ppm of nano-silver particles, the nano-silver particles having a diameter of less than 21 nm is utilized. In still other embodiments, the first polymeric compound may include polyvinyl-pyrrolidone, polypropylene, and polycarbonate for example.

At a next step 104, the pre-mix is concentrated. Concentrating, in one embodiment, is a process by which a colloidal suspension is thoroughly combined with a polymer. In one embodiment, the concentration achieved is approximately 500 ppm. In another embodiment, the concentration achieved is between approximately 200 ppm to 600 ppm. In still another embodiment, the concentration achieved is less than 20,000 ppm. Thus a sufficient amount of the first polymeric compound may be combined with the colloidal nano-silver to achieve a desired concentration. In one embodiment, pre-mix is processed in an extruder configured with an extruder screw having a length of at least 90 cm. By concentrating the pre-mix in this manner, uniform dispersion may be achieved resulting both in a more uniformly combined final product and in more efficient use of colloidal nano-silver.

At a next step 106, the pre-mix may be stored. In one embodiment, the storage device utilized may be configured with a mixing device. Storing the pre-mix may offer some manufacturing efficiencies because pre-mix may be made and stored in anticipation of some future demand. At a next step 108, the pre-mix is discharged to form a raw material. In some embodiments, the raw material is discharged through a die. Discharging through a die permits selection of a uniform or desired shape. Any shape or size may be selected in accordance with user preferences. At a next step 110, the raw material is reduced. Reducing may be accomplished in any manner well-known in the art. Thus, cutting, grinding, shaving, or otherwise reducing to a smaller, uniform size may be accomplished. As in a step 108, any size may be selected in accordance with user preferences.

At a next step 112, the raw material is dried. Drying allows for additional solvent used in the colloidal suspension to be removed. In one embodiment, drying takes place at a temperature between approximately 50° to 70° C. Drying further discourages growth of undesirable products such as molds for example. Drying may also result in reduced mass of the raw material. At a next step 114, an injection mix is made by combining raw material with a second polymeric compound. In one embodiment, the concentration achieved is between approximately 6 to 30 ppm. As can be appreciated, a concentration sufficient to achieve desired antibacterial results is desirable. As noted above, porosity of polymeric compounds may compromise sealing integrity of products produced using conventional methods. In embodiments described herein, pores created as a result of polymer-polymer complexes may be filled with nano-silver particles and nano-scale polymers bonded thereto. As such, compounds resulting from methods described herein may effectively block porosity such that undesirable gases may be reduced. Furthermore, presences of nano-silver particles may serve to further inhibit bacterial grow by interfering with bacterial reproduction. In one embodiment, the second polymeric compound may include, for example, polyvinyl-pyrrolidone, polypropylene, and polycarbonate.

Embodiments described herein have resulted in a nano-silver infused polymeric compound that exhibits antibacterial properties. The following results were achieved using above described methods:

Antibacterial activity (tested by a film sticking method (FC-TM-20)-2001) (number of bacteria per ml. and bacteria reduction rate in the units of %):

TABLE 1

| | | Blank | Sample |
|---|---|---|---|
| Strain 1 | # of inoculated bacteria | 1.5 × 10⁵ | 1.5 × 10⁵ |
| | After 24 hours | 1.5 × 10⁶ | <10 |
| | Bacteria reduction rate | — | 99.9% |
| | Increase rate | 46X | — |

TABLE 2

| | | Blank | Sample |
|---|---|---|---|
| Strain 2 | # of inoculated bacteria | 1.3 × 10⁵ | 1.3 × 10⁵ |
| | After 24 hours | 6.1 × 10⁶ | <10 |
| | Bacteria reduction rate | — | 99.9% |
| | Increase rate | 47X | — |

TABLE 3

| | | Blank | Sample |
|---|---|---|---|
| Strain 3 | # of inoculated bacteria | 1.6 × 10⁵ | 1.6 × 10⁵ |
| | After 24 hours | 7.7 × 10⁶ | <10 |
| | Bacteria reduction rate | — | 99.9% |
| | Increase Rate | 48X | — |

TABLE 4

| | | Blank | Sample |
|---|---|---|---|
| Strain 4 | # of inoculated bacteria | 1.5 × 10⁵ | 1.5 × 10⁵ |
| | After 24 hours | 6.5 × 10⁶ | <10 |
| | Bacteria reduction rate | — | 99.9% |
| | Increase rate | 43X | — |

TABLE 5

| | | Blank | Sample |
|---|---|---|---|
| Strain 5 | # of inoculated bacteria | 1.3 × 10⁵ | 1.3 × 10⁵ |
| | After 24 hours | 6.2 × 10⁶ | <10 |
| | Bacteria reduction rate | — | 99.9% |
| | Increase rate | 48X | — |

TABLE 6

| | | Blank | Sample |
|---|---|---|---|
| Strain 6 | # of inoculated bacteria | 1.6 × 10⁵ | 1.6 × 10⁵ |
| | After 24 hours | 7.8 × 10⁶ | <10 |
| | Bacteria reduction rate | — | 99.9% |
| | Increase rate | 49X | — |

TABLE 7

| | | Blank | Sample |
|---|---|---|---|
| Strain 7 | # of inoculated bacteria | 1.4 × 10⁵ | 1.4 × 10⁵ |
| | After 24 hours | 6.6 × 10⁶ | <10 |
| | Bacteria reduction rate | — | 99.9% |
| | Increase rate | 47X | — |

TABLE 8

| | | Blank | Sample |
|---|---|---|---|
| Strain 8 | # of inoculated bacteria | 1.5 × 10⁵ | 1.5 × 10⁵ |
| | After 24 hours | 6.5 × 10⁶ | <10 |
| | Bacteria reduction rate | — | 99.9% |
| | Increase rate | 43X | — |

TABLE 9

| | |
|---|---|
| Strain 1 | Bacillus cereus ATCC 9634 |
| Strain 2 | Escherichia coli ATCC 43895 (0–157) |
| Strain 3 | Klebsiella pneumoniae ATCC 4352 |
| Strain 4 | Pseudomonas aeruginasa ATCC 27853 |
| Strain 5 | Salmonella typhimurium KCTC 1925 |
| Strain 6 | Shigella flexneri ATCC 9199 |
| Strain 7 | Staphylococcus aureus ATCC 538 |
| Strain 8 | Vibrio parahaemolyticus ATCC 17802 |

While this invention has been described in terms of several embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A method of manufacturing a nano-silver infused polymeric compound comprising:
combining a colloidal nano-silver solution with a first polymeric compound to form a pre-mix;
concentrating the pre-mix to a first concentration;
discharging the pre-mix through a die such that a first raw material is formed;
drying the first raw material at a first temperature; and
combining the first raw material with a second polymeric compound to form the nano-silver infused polymeric compound to a second concentration, the nano-silver infused polymeric compound suitably disposed for a molding process.

2. The method of claim 1 further comprising:
after the concentrating the pre-mix, storing the pre-mix; and
after the discharging the pre-mix, reducing the first raw material to a first size.

3. The method of claim 1 wherein the colloidal nano-silver solution comprises:
a colloidal concentration of at least 10,000 ppm of nano-silver particles, the nano-silver particles having a diameter of less than 10 nm; and
a colloidal solvent.

4. The method of claim 1 wherein the colloidal nano-silver solution comprises:
a colloidal concentration of at least 10,000 ppm of nano-silver particles, the nano-silver particles having a diameter of less than 21 nm; and
a colloidal solvent.

5. The method of claim 3 wherein the colloidal solvent is selected from the group consisting of: distilled water, pure water, ethanol, and ethylene glycol.

6. The method of claim 4 wherein the colloidal solvent is selected from the group consisting of: distilled water, pure water, ethanol, and ethylene glycol.

7. The method of claim 1 wherein the first polymeric compound is selected from the group consisting of: polyvinyl-pyrrolidone, polypropylene, and polycarbonate.

8. The method of claim 1 wherein the first concentration is between approximately 200 ppm to 600 ppm of nano-silver particles.

9. The method of claim 1 wherein the concentrating the pre-mix to a first concentration is processed with an extruder, the extruder configured with an extruder screw having a length of at least 90 cm.

10. The method of claim 1 wherein the first temperature is between approximately 50° to 70° C.

11. The method of claim 1 wherein the second polymeric compound is selected from the group consisting of: polyvinyl-pyrrolidone, polypropylene, and polycarbonate.

12. The method of claim 1 wherein the second concentration is between approximately 6 to 30 ppm of nano-silver particles.

13. A nano-silver infused polymeric composition comprising:
a colloidal nano-silver solution;
a first polymeric compound combined with the colloidal nano-silver solution to form a pre-mix compound at a first concentration; and
a second polymeric compound combined with the pre-mix compound at a second concentration.

14. The composition of claim 13 wherein the colloidal nano-silver solution comprises:
a colloidal concentration of at least 10,000 ppm of nano-silver particles, the nano-silver particles having a diameter of less than 10 nm; and
a colloidal solvent.

15. The composition of claim 13 wherein the colloidal nano-silver solution comprises:
a colloidal concentration of at least 10,000 ppm of nano-silver particles, the nano-silver particles having a diameter of less than 21 nm; and
a colloidal solvent.

16. The composition of claim 14 wherein the colloidal solvent is selected from the group consisting of: distilled water, pure water, ethanol, and ethylene glycol.

17. The composition of claim 15 wherein the colloidal solvent is selected from the group consisting of: distilled water, pure water, ethanol, and ethylene glycol.

18. The composition of claim 13 wherein wherein the first polymeric compound is selected from the group consisting of: polyvinyl-pyrrolidone, polypropylene, and polycarbonate.

19. The composition of claim 13 wherein the first concentration is between approximately 200 ppm to 600 ppm of nano-silver particles.

20. The composition of claim 13 wherein the second polymeric compound is selected from the group consisting of: polyvinyl-pyrrolidone, polypropylene, and polycarbonate.

21. The composition of claim 13 wherein the second concentration is between approximately 6 to 30 ppm of nano-silver particles.
